(19) United States
(12) Patent Application Publication
(10) Pub. No.: US 2010/0033858 A1
(43) Pub. Date: Feb. 11, 2010

(54) REAR VIEWING DEVICE AND ASSOCIATED METHODS

(76) Inventor: Violet Lucille Weech, Nassau (BS)

Correspondence Address: Zies Widerman & Malek, P.L., 202 N. Harbor City Blvd, Suite #101, Melbourne, FL, 32935, US

(21) Appl. No.: 12/497,764

(22) Filed: Jul. 6, 2009

Related U.S. Application Data
(60) Provisional application No. 61/087,700, filed on Aug. 10, 2008.

(51) Int. Cl. G02B 7/182

(52) U.S. Cl. 359/879

(57) ABSTRACT

A rear viewing device includes an elongate main body member having a first end, a second end and a medial portion positioned between the first end and the second end. The medial portion may include a pocket formed therein. The rear viewing device may also include a mirror adapted to be removeably carried by the pocket formed in the medial portion of the elongate main body member. The rear viewing device may also include respective fasteners carried by the first end and the second end of the elongate main body member. The respective fasteners may be adapted to matingly engage one another so that the elongate main body member may be worn by a user.

### RELATED APPLICATIONS

This application claims the benefit of U.S. Provisional Patent Application Ser. No. 61/087,700 titled Security Mirrored Wrist Band filed on Aug. 10, 2008, by the inventor of the present invention, the entire contents of which are incorporated herein by reference.

### FIELD OF THE INVENTION

The present invention relates to the field of accessories to be used for security purposes and associated methods.

### BACKGROUND OF THE INVENTION

Spending time outdoors is an activity that is enjoyed by many. Some people enjoy engaging in such outdoor activities as walking, jogging or other physical activities. Security is generally a concern for people as they are engaging in such activities. This is especially a concern due to the possibility of an attacker following a person, and possibly even attacking the person by surprise from behind. More specifically, in recent years, there have been instances where people have been attacked or confronted by surprise from behind by an assailant. When people are engaging in certain activities, such as jogging or even riding on stationary equipment, it is impossible, generally, for the person to view their surroundings. This is because when engaging in such activities, people should generally stay focused on where they are going so as not to collide with anything. Similarly, in the case of being on stationary equipment, the user should stay focused and not try to look around them so as to ensure that they are keeping balanced.

This security problem also exists when engaging in everyday activities. For example, there is the common concern of walking to one's vehicle in a dark parking lot and not being able to observe one's surroundings. There have been all too many news stories regarding attacks in parking lots because assailants are able to take their victims by surprise by hiding outside of the victim's line of sight. With the above in mind, it is desirable for a person to have a convenient way to observe their surroundings behind them. By allowing persons engaging in everyday activities as well as in the physical activities mentioned above, the ability to readily view their surroundings the activities are likely to be more enjoyed, and security of such persons is likely to be enhanced.

Some devices have been developed to allow a user to view their surroundings that may not be in their line of sight. For example, U.S. Pat. No. 5,361,169 to Deal discloses a diving mirror that may be worn by a user so that the diver can inspect equipment on his body or easily access equipment with the hand not wearing the mirror. The diving mirror disclosed in the Deal '169 patent is stored within a housing, or may even be completely enclosed and carried within a pocket. In such an embodiment, the mirror is connected to a tether so that a user may remove the mirror from the pocket, use the mirror to view the equipment and replace the mirror in the pocket when finished. The mirrors carried within the housing include a cover that must be moved to an open position to be used. In either embodiment, the user is required to use two hands in order to access the mirror.

Other devices have been developed to allow users engaging in activities to view surroundings not in their line of sight such as, for example, the rear view cycling mirror disclosed in U.S. Pat. No. 4,054,375 to Ribeca. The cycling mirror is adapted to be carried by the handlebars of a bicycle so that a cyclist may have a rear view while riding. The mirror is contained within a case, and may be connected to a strap to be worn by a user. More particularly, the case is moveable between and opened and a closed position. The top portion of the case may carry the mirror so that when the case is moved to the opened position, the mirror is adapted to provide a user with a rear view. Similar to the device disclosed in the Deal '169 patent, the rear view mirror disclosed in the Ribeca '375 patent requires a user to use two hands to use the mirror when being worn by the rider.

### SUMMARY OF THE INVENTION

In view of the foregoing, it is therefore an object of the present invention to provide a rear viewing device that enables a user to view their surroundings that are not in their line of sight. It is also an object of the present to provide a rear viewing device that is easy to use and that may be comfortably worn by a user. It is further an object of the present invention to provide a rear viewing device that includes a mirror that is removable and that is also easily secured to prevent loss and/or breakage.

These and other objects, features and advantages of the present invention are provided by a rear viewing device that includes an elongate main body member having a first end, a second end and a medial portion positioned between the first end and the second end. The elongate main body member also includes a pocked formed in the medial portion thereof. The rear viewing device may also include a mirror adapted to be removeably carried by the pocket formed in the medial portion of the elongate main body member. The rear viewing device may further include respective fasteners carried by the first end and the second end of the elongate main body member. The respective fasteners may be adapted to matingly engage one another so that the elongate main body member may be worn by a user.

The pocket may include an elongate opening adjacent either the first end or the second end of the elongate body member. The opening is advantageously adapted to receive the mirror. The pocket may include an opening formed in a top portion thereof to expose the mirror when the mirror is carried thereby. Accordingly, the mirror may advantageously be viewable by a user when carried within the pocket. The opening formed in the top portion of the pocket preferably has a perimeter that is smaller than the perimeter of the mirror. This advantageously allows the mirror to be secured within the pocket when carried thereby. The pocket is preferably a four sided pocket, and three of the four sides of the pocket are closed.

The respective fasteners may be provided by hook and loop fasteners, snap fasteners or may be provided by a buckle fastener. The rear viewing device may also include ornamentation affixed to an outer portion of the elongate main body member. The ornamentation advantageously enhances the aesthetics of the rear viewing device. The elongate main body member and the pocket may integrally formed as a monolithic unit.

A method aspect of the present invention is for using the rear viewing device. The method includes removeably inserting a mirror into the pocket formed in the medial portion of the elongate main body member.

### BRIEF DESCRIPTION OF THE DRAWINGS

FIG. 1 is an environmental view showing a user wearing the rear viewing device according to the present invention.

FIG. 2 is a rear environmental view of a user using the rear viewing device taken from the perspective of line 2-2 in FIG. 1.

FIG. 3 is a detailed view of the rear viewing device illustrated in FIG. 2 and showing a view from behind the user.

FIG. 4 is a top plan view of the rear viewing device according to the present invention.

FIG. 5 is a top plan view of the rear viewing device illustrated in FIG. 4 and showing a mirror being removed from the pocket.

FIG. 6 is a top plan view of the rear viewing device according to the present invention and having ornamentation connected to the elongate main body member thereof.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and multiple prime notations refer to similar elements in alternate embodiments.

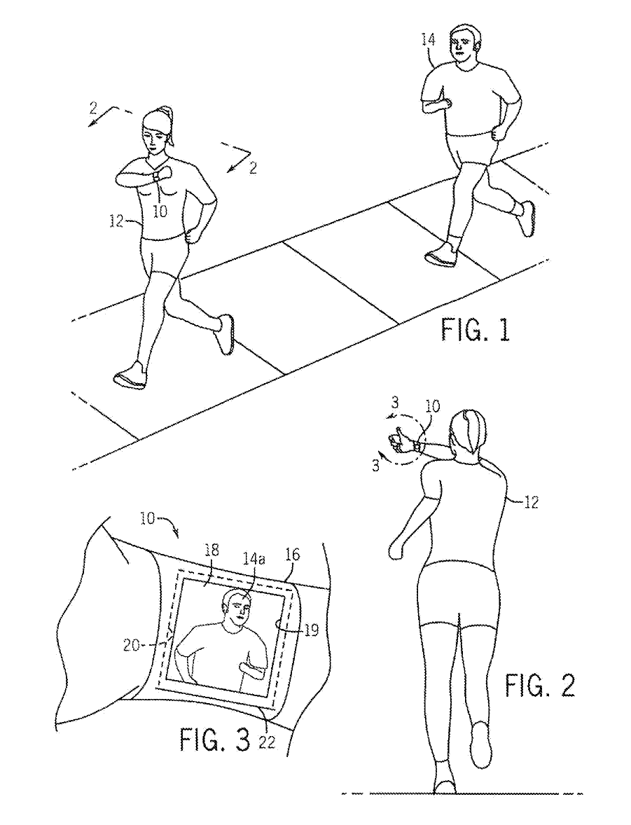

Referring initially to FIGS. 1-3, the rear viewing device 10 according to the present invention is now described in greater detail. The rear viewing device 10 is preferably worn by a user, i.e., a jogger 12 to provide a view of the jogger's surroundings. More specifically, and as perhaps best illustrated in FIG. 1, the user 12 may use the rear viewing device 10 to view another jogger 14, for example, that may be behind the user. As illustrated in FIG. 3, for example, the rear viewing device 10 according to the present invention advantageously provides the user 12 with an image 14A of the jogger 14 that is positioned behind the user.

As illustrated, for example in FIG. 2, the rear viewing device 10 is adapted to be worn on the wrist of a user 12. Those skilled in the art, however, will appreciate that the rear viewing device 10 may be carried by the user 12 in any other manner so that the rear viewing device 10 provides an image to the user that is not within the user's line of sight. For example, the user 12 may choose to carry the rear viewing device 10 in his/her hand, or any other type of configuration. Those skilled in the art will also appreciate that the rear viewing device 10 according to the present invention may also be used to monitor one's surroundings and stationary activities. For example, the user 12 may use the rear viewing device 10 according to the present invention when on a stationary bicycle, for example, or any other type of stationery exercise activity. The user 12 may simply wear the rear viewing device 10, as illustrated, for example, in FIG. 2, or may affix the rear viewing device to the stationary exercise equipment to be able to readily view his/her surroundings.

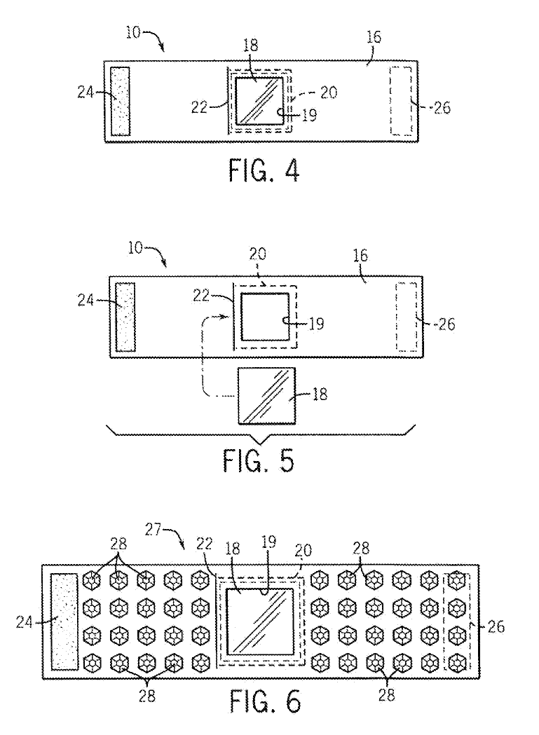

Referring now additionally to FIGS. 4-6, additional features of the rear viewing device 10 according to the present invention are now described in greater detail. The rear viewing device 10 illustratively includes an elongate main body member 16 that includes a first end and a second end opposite the first end. The elongate main body member 16 also includes a medial portion positioned between the first end and the second end. The medial portion includes a pocket 20 formed therein.

The rear viewing device 10 according to the present invention also includes a mirror 18 adapted to be removeably carried by the pocket 20 formed in the medial portion of the elongate main body member 16. The rear viewing device 10 according to the present invention also includes respective fasteners 24, 26 carried by the respective first end and second end of the elongate main body member 16. The respective fasteners 24, 26 are adapted to matingly engage one another so that the elongate main body member 16 may be worn by the user 12. As discussed above, however, the present invention contemplates that the respective fasteners 24, 26 may be used to fasten the rear viewing device 10 to a piece of stationary equipment. Those skilled in the art will also appreciate that the rear viewing device 10 may also be fastened to a bicycle, for example, so that the user 12 may also be able to observe their surroundings that are not within their line of sight, i.e., behind the user. This may be especially helpful when using the rear viewing device 10 while riding a bicycle in traffic so that the user 12 may view traffic coming from behind.

The pocket 20 formed in the medial portion of the elongate main body member 16 may also include an elongate opening 22. The opening 22 is positioned adjacent either the first end or the second end of the elongate main body member 16. Further, the opening 22 is adapted to receive the mirror 18. More specifically, the opening 22 in the pocket 20 preferably has a length that is longer than the length of any side of the mirror 18 so that the mirror may be inserted into the pocket and be carried thereby.

The pocket 20 formed in the medial portion of the elongate main body member 16 also includes an opening 19 formed in a top portion thereof to expose the mirror 18 when the mirror is carried thereby. The opening 19 in the top portion of the pocket 20 may be configured so that the mirror 18 is exposed when carried by the pocket 20. Those skilled in the art will also appreciate that a clear material may be used to cover the opening 19 in the top portion of the pocket 20 to provide protection to the mirror 18. The clear material may, for example, be provided by a plastic cover, but those skilled in the art will appreciate that the clear material may be provided by any material that allows for the mirror 18 to be readily viewable by the user 12 while simultaneously protecting the mirror. The opening 19 formed in the top portion of the elongate main body member 16 has a perimeter that is preferably smaller than the perimeter of the mirror 18. More specifically, it is preferable that the length of each side of the opening 19 in the top portion of the pocket 20 be smaller than a corresponding length of the mirror 18 when the mirror is carried by the pocket. This advantageously allows for the mirror 18 to be secured within the pocket 20 and, more specifically, prevents the mirror from slipping out of the pocket via the opening 19 in the top portion of the pocket.

The figures illustrate a four-sided pocket 20, but those skilled in the art will appreciate that the pocket may have any shape. Similarly, the mirror 18 held by the pocket 20 may also have any shape corresponding to the shape of the pocket. As perhaps best illustrated in FIG. 3, the illustrated pocket 20 is preferably a four-sided pocket 20. Three of the four sides of the pocket 20 are preferably closed. More specifically, three sides of the pocket 20 may be formed by stitching the pocket material to the medial portion of the elongate main body member 16. The present invention contemplates that the elongate main body member 16 and the pocket 20 may be integrally formed as a monolithic unit. Those skilled in the art will appreciate that the pocket 20 may be formed in any number of ways that are also suitable to secure the mirror 18 to the medial portion of the elongate main body member 16.

As discussed above, the rear viewing device 10 also includes a pair of respective fasteners 24, 26. The respective fasteners 24, 26 may be provided by using hook and loop fasteners. The fasteners 24, 26 may also be provided by a snap fastener or a buckle. Those skilled in the art will appreciate that the present invention contemplates several different types of fasteners 24, 26 suitable for securing the first end of the elongate main body member 16 to the second end of the elongate main body member so that the rear viewing device 10 may be worn by a user 12, or may be secured to a device to allow the user to readily view his/her surroundings.

Referring now more specifically to FIG. 6, a second embodiment of the rear viewing device 27 is now described in greater detail. The second embodiment of the rear viewing device 27 illustratively includes ornamentation 28 affixed to the elongate main body member 16. The ornamentation 28 may, for example, be provided by rhinestones, or any other type of ornamentation to enhance the aesthetics of the rear viewing device 27 according to the present invention. Those skilled in the art will appreciate that the ornamentation 28 may be affixed in any pattern to the elongate main body member 16, and using any means known to affect the ornamentation thereto. The ornamentation 28 is advantageously affixed to an outer portion of the elongate main body member 16 so as to be visible when the ends of the elongate main body member are fastened to one another. The remaining features of this embodiment of the rear viewing device 27 are similar to those of the first embodiment of the rear viewing device 10 and require no further discussion herein.

The rear viewing device 10 according to the present invention contemplates that the mirror 18 may be secured by overlapping portions of the pocket 20 on all four sides of the mirror. The present invention also contemplates holding the mirror 18 in place using snaps on two or three sides thereof. The elongate main body member 16 of the rear viewing device 10 according to the present invention may be made of a leather material, or any type of stretch material such as elastic, for example. Further, the elongate main body member 16 may be made in a variety of colors to accommodate the tastes of several different types of users. The rear viewing device 10 according to the present invention also contemplates that the mirror 18 may be more permanently affixed to the elongate main body member 16. In other words, the mirror 18 may be permanently glued to a medial portion of the elongate main body member 16 within the pocket 20.

A method aspect of the present invention is for using the rear viewing device 10. The method may include removeably inserting a mirror 18 into the pocket 20 formed in the medial portion of the elongate main body member 16. The method may also include connecting fasteners 24, 26 to one another so that the elongate main body member 16 may be worn by a user 12, or may be attached to a stationary device. The method may still further include removing the mirror 18 from within the pocket 20 of the elongate main body member 16.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A rear viewing device comprising:
an elongate main body member having a first end, a second end and a medial portion positioned between the first end and the second end, the medial portion including a pocket formed therein;
a mirror adapted to be removeably carried by the pocket formed in the medial portion of said elongate main body member; and
respective fasteners carried by the first end and the second end of said elongate main body member, said respective fasteners being adapted to matingly engage one another so that said elongate main body member may be worn by a user.

2. A rear viewing device according to claim 1 wherein the pocket includes an elongate opening adjacent at least one of the first end and the second end of said elongate body member, said opening adapted to receive the mirror.

3. A rear viewing device according to claim 1 wherein the pocket includes an opening formed in a top portion thereof to expose the mirror when the mirror is carried thereby.

4. A rear viewing device according to claim 3 wherein the opening formed in the top portion has a perimeter that is smaller than the perimeter of the mirror.

5. A rear viewing device according to claim 1 wherein the pocket is a four sided pocket, and wherein three of the four sides of the pocket are closed.

6. A rear viewing device according to claim 1 wherein said respective fasteners are provided by hook and loop fasteners.

7. A rear viewing device according to claim 1 wherein said respective fasteners are provided by snap fasteners.

8. A rear viewing device according to claim 1 wherein said respective fasteners are provided by a buckle fastener.

9. A rear viewing device according to claim 1 further comprising ornamentation affixed to an outer portion of said elongate main body member.

10. A rear viewing device according to claim 1 wherein said elongate main body member and the pocket are integrally formed as a monolithic unit.

11. A rear viewing device comprising:
an elongate main body member having a first end, a second end and a medial portion positioned between the first end and the second end, the medial portion including a pocket formed therein, wherein the pocket includes an elongate opening adjacent at least one of the first end and the second end of said elongate body member;
a mirror adapted to be removeably carried by the pocket formed in the medial portion of said elongate main body member; and
respective fasteners carried by the first end and the second end of the elongate main body member, said respective fasteners being adapted to matingly engage one another so that said elongate main body member may be worn by a user, wherein said respective fasteners are provided by at least one of hook and loop fasteners, snap fasteners and a buckle fasteners; and
ornamentation affixed to an outer portion of said elongate main body member;
wherein said elongate main body member and the pocket are integrally formed as a monolithic unit.

12. A rear viewing device according to claim 11 wherein the pocket includes an opening formed in a top portion thereof to expose the mirror when the mirror is carried thereby.

13. A rear viewing device according to claim 12 wherein the opening formed in the top portion has a perimeter that is smaller than the perimeter of the mirror.

14. A rear viewing device according to claim 11 wherein the pocket is a four sided pocket, and wherein three of the four sides of the pocket are closed.

15. A method of using a rear viewing device including an elongate main body member having a first end, a second end and a medial portion positioned between the first end and the second end, the medial portion including a pocket having an elongate opening adjacent at least one of the first end and the second end of the elongate main body member formed therein, respective fasteners carried by the first end and the second end of the elongate main body member, the respective fasteners being adapted to matingly engage one another so that the elongate main body member may be worn by a user,
removeably inserting a mirror into the pocket formed in the medial portion of the elongate main body member.

16. A method according to claim 15 wherein the pocket includes an opening formed in a top portion thereof to expose the mirror when the mirror is carried thereby and wherein the opening formed in the top portion has a perimeter that is smaller than the perimeter of the mirror.

17. A method according to claim 15 wherein the pocket is a four sided pocket, and wherein three of the four sides of the pocket are closed.

18. A method according to claim 15 wherein the respective fasteners are provided by at least one of hook and loop fasteners, snap fasteners and a buckle fasteners.

19. A method according to claim 15 wherein ornamentation is affixed to an outer portion of the elongate main body member.

20. A method according to claim 15 wherein the elongate main body member and the pocket are integrally formed as a monolithic unit.
